(19) United States
(12) Patent Application Publication
(10) Pub. No.: US 2007/0257126 A1
(43) Pub. Date: Nov. 8, 2007

(54) MITIGATION OF TROPICAL CYCLONE INTENSITY AND DAMAGE

(76) Inventor: David J.M. Vondracek, Clearwater, FL (US)

Correspondence Address: PILLSBURY WINTHROP SHAW PITTMAN LLP, P.O. BOX 10500, MCLEAN, VA, 22102, US

(21) Appl. No.: 11/744,204

(22) Filed: May 3, 2007

Related U.S. Application Data
(60) Provisional application No. 60/746,317, filed on May 3, 2006.

(51) Int. Cl. A01G 15/00; E01H 13/00

(52) U.S. Cl. 239/2.1

(57) ABSTRACT

High sea surface temperatures (SST) are a major factor in the formation and maintenance of tropical cyclones. Global warming has contributed to a rise in SSTs causing an increase in tropical cyclone formation. This increase in SSTs in the Atlantic basin is attributed to failing of the ThemoHaline Currents (THC) that provides warm ocean waters to Europe. Should the THC fail, it is estimated that Europe would be plunged into a 200-400 year ice age. The invention described herein uses OTEC or similar technology to pump cold ocean water to the surface, reducing SSTs limiting the formation and growth of tropical cyclones. Additional benefits would include strengthening of the THC as well as providing a stop-gap solution for global warming while more responsible manufacturing and industrial methods are designed and implemented. With limited additions to the OTEC platform other benefits can be derived including but not limited to mariculture, algaeculture, biodiesel and ethanol production, and carbon sequestration.

### CLAIM OF PRIORITY

This application claims priority to U.S. Provisional Appln. Ser. No. 60/746,317 filed May 3, 2006 entitled Mitigation of Tropical Cyclone Intensity and Damage,” the contents of which are incorporated by reference herein in their entirety.

### BACKGROUND OF THE INVENTION

### Field of the Invention

This invention generally relates to weather modification, specifically relates to cooling ocean surface temperatures for mitigation of tropical cyclones, carbon sequestration and ThermoHaline Current increase.

### Background of the Invention

Previously, most solutions to hurricane devastation have been directed at preventing damage to property. A singular example of such would be U.S. Pat. No. 6,363,670 to Dewitt “Hurricane Protection System.” While effective at protecting some objects; does not provide a large scale solution to the problem such as provided by weather modification.

Weather modification experiments have been mostly limited to cloud seeding experiments. Project Storm Fury (http://www.aoml.noaa.gov/hrd/hrd_sub/sfury.html) 1962-1983 was a US government research project attempting to reduce hurricane intensity. While not successful at reducing the intensity of hurricanes, StormFury did provide useful scientific information leading to further weather modification experiments. Such patents as U.S. Pat. No. 6,315,213 to Cordani (2001)—“Method of modifying weather” and its prior art describe detailed methods for changing weather. While successful in their own right these techniques are not large enough in scope to effectively reduce the intensity of a hurricane.

Conversely, patents such as U.S. Pat. No. 5,492,274 to Assaf, et al, “Method of and means for weather modification” and U.S. Pat. No. 4,470,544 to Assaf, et al, “Method of and means for weather modification” intentionally store heat energy in ocean water, creating opposite of the desired effect and provides more fuel to form and feed tropical cyclones.

The National Oceanic and Atmospheric Administration (NOAA) provides a listing of presented theories for destroying hurricanes at (http://www.aoml.noaa.gov/hrd/tcfaq/tcfaqC.html), though the theories are referenced as being beyond our technical, financial and logistics capabilities.

Global warming is at the heart of the increase in hurricane intensity and frequency of recent years. John Martin (http://earthobservatory.nasa.gov/Library/Giants/Martin/martin.html) was a pioneer at Oceanic Engineering towards the aim of utilizing the ocean's vast resources as a method of controlling global warming. His experiments with seeding oceans with iron to produce algae blooms show promise in controlling the green house gas carbon. Unfortunately, there are two limiting factors in the method utilized by Martin's experimentation. Namely, the method of deployment via small ship requires an enormous fleet constantly deployed at high cost. Also, certain experiments showed that there are other limiting nutrient factors in algae growth besides iron such as zinc.

Another impact of global warming according to “Slowing of the Atlantic meridional overturning circulation at 25° N″ Harry L. Bryden, Hannah R. Longworth, Stuart A. Cunningham Nature 438, 655-657 (1 Dec. 2005) ThemoHaline Currents (THC)—the deep ocean currents that transport heat and nutrients throughout the Earth's oceans is beginning to fail. Should the THC fail, it is predicted that all of Europe would be plunged into an ice age lasting 200-400 years. The primary suspect of THC failure is global warming and specifically high SSTs in the Gulf of Mexico and Caribbean Seas.

FIG. 1 illustrates a known system 100 that creates energy based upon pumped cold water and the interaction of the pumped cold water with warmer surface water under very low compression, which system 100 uses a device known as a Ocean Thermal Energy Conversion (OTEC) device, and is described in U.S. Pat. No. 2,006,985 to Claude G. and Boucherot, P. “Method and Apparatus for Obtaining Power from the Sea.” This pumping device 10 discharges the operated upon sea water, which has been used for energy conversion, back to the ocean, as shown at discharge tube 20.

While such an OTEC pumping device is known and, after energy conversion, the used water is removed from the OTEC pumping device is pumped to back to the ocean, with the discharge being provided via a single discharge tube, such that the used water, being substantially colder than the surface sea water, will naturally drop from the surface to the depths of the ocean.

### SUMMARY OF THE INVENTION

This invention generally relates to weather modification, specifically relates to cooling ocean surface temperatures for mitigation of tropical cyclones.

In one aspect there is described a method of lowering sea surface temperatures to reduce tropical cyclone intensity using a plurality of pumping distribution devices that pump cold sea water from a sea depth to a sea surface. The method includes positioning a plurality of the pumping distribution devices along sea currents; pumping the cold sea water from the sea depth to the sea surface with each of the plurality of pumping distribution devices; obtaining discharge water having a lower temperature than the surface sea water, wherein water derived from the cold sea water is used to obtain the discharge water; and returning the discharge water to a predetermined area of the sea surface in a quantity sufficient to obtain cooled surface water and affect a cooling of at least a 1,000 square kilometers area of the surface water, thereby limiting tropical cyclone intensity of any tropical storm over the at least 1,000 square km area.

In a preferred aspect, the method also includes the usage of the pumped deep sea water for energy production.

In another aspect, there is described a distribution system that generates electricity and reduces surface temperature of surface sea water using deep sea water.

In a particular aspect, the distribution system includes a thermal energy conversion device that uses the deep sea water and the surface sea water to produce electricity and that provides used water that has a temperature that is cooler than the surface sea water at the sea surface; and a water distribution system for continuously distributing over a period of time the discharge water over the sea surface to reduce the surface temperature of the surface sea water, the water distribution system including a mixing tank that produces discharge water that has a temperature within a range of 2-18° C. of sea surface water temperature using at least the used water.

### BRIEF DESCRIPTION OF THE DRAWINGS

These and other aspects and features of the present invention will become apparent to those of ordinary skill in the art upon review of the following description of specific embodiments of the invention in conjunction with the accompanying figures, wherein:

FIG. 1 is a conventional OTEC platform according to the prior art.

FIG. 2 is an OTEC platform distribution system according to the present invention.

FIG. 3 illustrates a preferred OTEC distribution system according to the present invention.

FIG. 4 illustrates a distribution system according to the present invention that also includes other features.

FIG. 5 illustrates an example placement of distribution systems in the Atlantic Basin.

FIG. 6 illustrates two adjacent distribution systems and the effected sea surface water area therearound according to the present invention.

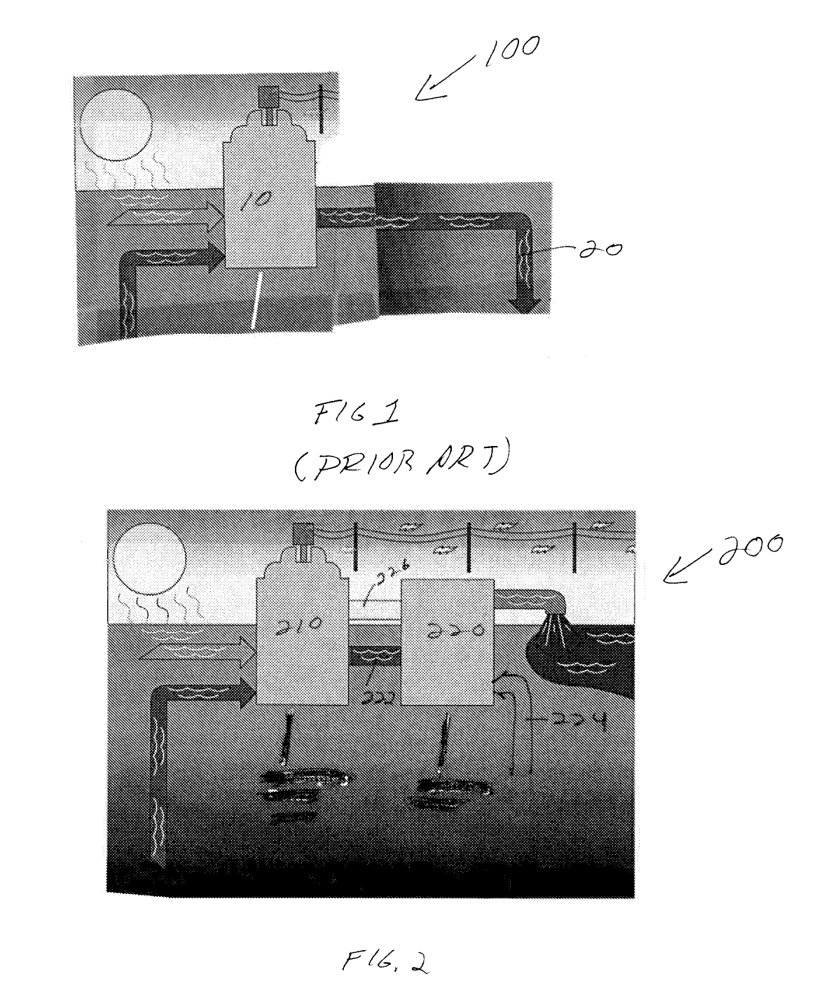

### DETAILED DESCRIPTION OF THE PREFERRED EMBODIMENTS

Aspects of the present invention that are advantageous are numerous. Certain of these advantageous aspects are discussed in the following paragraphs. It should be noted that within the application certain words are used interchangeably, in particular the usage of sea and ocean.

Affecting tropical cyclones as a system, not merely protecting individual dwellings from destruction. This also improves on cloud seeding methods as the whole system can be affected not just a limited area.

Lowered sea surface temperatures (SST) limiting formation and sustenance of tropical cyclones. Formed tropical storms entering the effected region would be deprived of feedback energy provided by warm SSTs and decrease in intensity. The invention is a proactive solution to tropical cyclones, not reactive.

A constantly deployed and operational pump distribution system, described further hereinafter, creates and maintain an environment not suitable for tropical cyclone formation. Additional benefits are safely returning native environments to their natural temperatures that have been altered by global warming. Such environmental issues as red tide and coral bleaching would subside.

Commercial viability allows the pump distribution system to pay for its maintenance and operation, not being a financial liability.

Pumping of deep sea waters also provides a constant supply of a variety of nutrient minerals for algae production. Additional quantities of limiting nutrients could be added to the natural deep sea mix as necessary to foster abundant algae growth positively effecting carbon sequestration and global warning.

Reduction of SSTs over the entire Gulf of Mexico and Caribbean Sea areas would contribute to the strengthening of the THC that provides necessary heat energy and nutrients to the seas surrounding Europe.

Further advantages will become apparent from a consideration of the ensuing description.

A series of pump distribution systems positioned along current flow lines are also preferably adapted for the commercial generation of electricity and distilled water, as well as other byproducts, as will be described further herein.

FIG. 2 illustrates a pump distribution system 200 that preferably includes an OTEC pump device 210 such as the described in U.S. Pat. No. 2,006,985 previously. The OTEC pumping device 210 obtains cold sea water from typically about 1,000 meters, instead of taking the cold sea water used for energy production and placing it directly back into the sea at a lowe level such as 800 meters via a single discharge tube as described in the '985 patent, the present invention instead passes the used cold sea water to a mixing tank 220, through an inlet 222, which mixing tank 220 can also introduce, if desired, further deep sea water via a deep see water inlet 224. The used water that is introduced to the mixing tank 220 includes the cold sea water that is used in the pump device 210 to cause condensation (and as such does not directly mix with warn water within the pump device 210, though its temperature is slightly raised due to the heat transfer that takes place). Although distilled water is also a byproduct of the pumping device 210, such distilled water, since pure and sanitary for human consumption, will typically not be introduced into the mixing tank 220, and as such is not illustrated. There is, however, other water that is fed out of the device 210 consisting of the used warm surface waters, though its temperature is slightly reduced due to the heat transfer that takes place and this other warmer water can be provided to the mixing tank, as is shown via inlet 226. The mixing tank 220 creates discharge water that is properly mixed for salinity, density and/or temperature, is then discharged from the mixing tank 220 and is placed, using a distribution system 230, back into the ocean in a distributed manner so that it remains at the surface of the ocean to allow for cooling of the temperature of the sea water at the sea surface. In terms of proper mixing, it is desirable that the discharge water is within a range of temperature of the sea surface water, preferably within about 2-18° C., so that the discharge water actually mixes with the sea surface water, rather than being at larger temperature differential and thereby quickly flowing below the sea surface water rather than mixing with the sea surface water. Thus, this allows reduction of the temperature of the surface sea water to at or below 26° C.

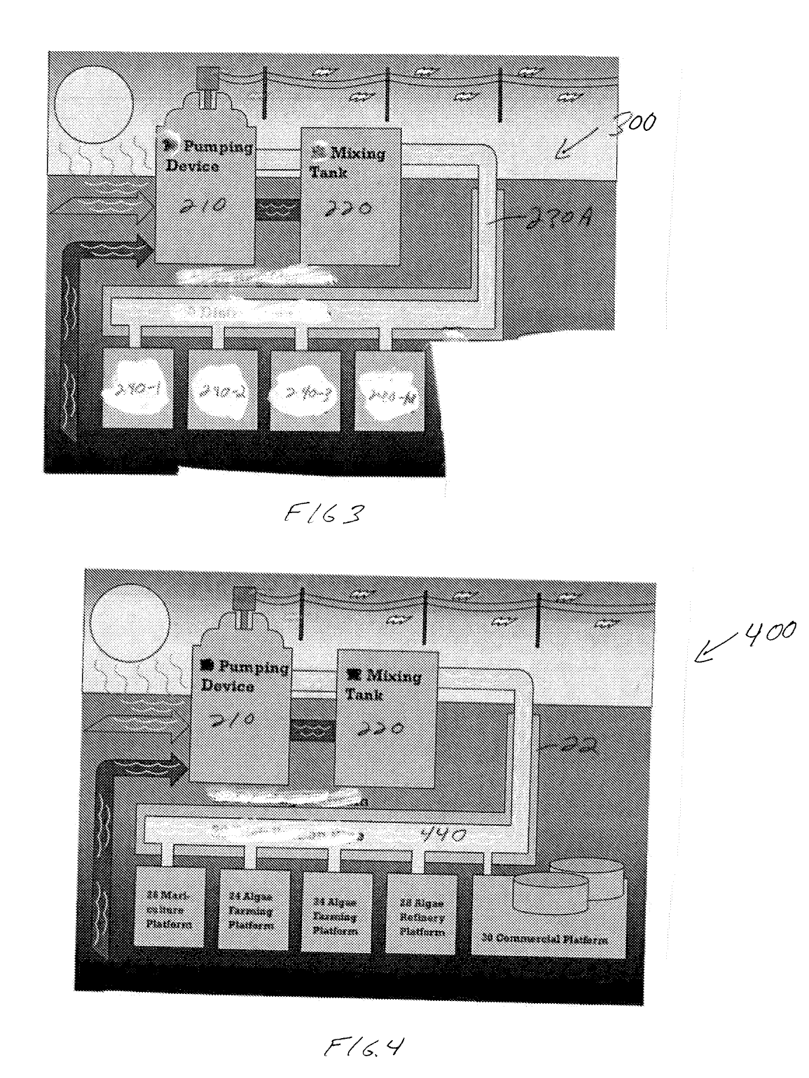

FIG. 3 shows a preferred distribution system 300. Pumping device 210 again discharges the used water to mixing tank 220, the sea water discharge of which is then is distributed via a distribution system 230A that includes an array of distribution outlets 240-1, 240-2, 240-3 . . . 240-n as shown, which distribute the discharge water to a plurality of locations around the water distribution system 300.

The distribution system 400, as shown in FIG. 4, can also include a floating platform 22, which can be used to distribute some of the pumped cold sea water to areas for activities in addition to the usage of the cold sea water for surface cooling. As shown a distribution system 440 distributes cold sea water that can be then used for growing mangroves and other estuary plants as well as algae farming platforms 24, mariculture platforms 26, algae refineries 28, commercial docks 30 and/or platforms for various other uses. Use of the distribution system 300 allows cooling of the sea surface, while providing other benefits such as electrical power generation and desalinated water. With limited additions to the distribution system 300, other benefits can be derived including but not limited to: mariculture from mariculture platforms 26, algae culture from algae farming platforms 24, biodiesel and ethanol production from algae refineries 28, and carbon sequestration—the carbon being absorbed as a requirement of algae production. Such commercial platforms, while not required, can also be used to further extend the output range of the distribution system 230A by creating a series of outlets for the discharge water, thus creating less of an impact on a localized area, and reducing the need for ocean currents to spread the discharge water.

The cool sea water that is pumped to the surface, in addition to being used as a component for the OTEC pumping device 210, can also be used to provide an environment for growing large quantities of cold water fish and shellfish not indigenous to tropical regions.

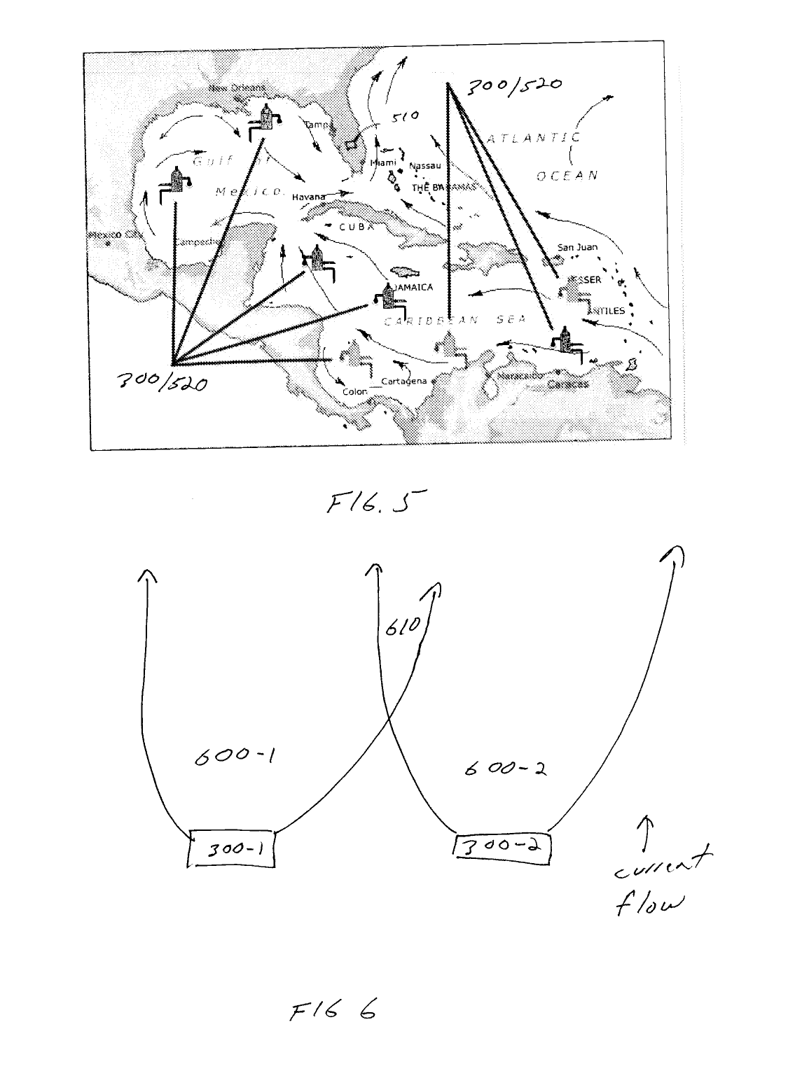

FIG. 5 displays a sample distribution of distribution systems 300 positioned at different locations along existing ocean currents in the Atlantic Basin to aid in distribution of the cool sea water at surface areas along the Atlantic Basin. This is representative and not to scale, as a 100 MW plant system 300 cycles through 265,000 kg seawater per second. If that amount of cold water is mixed into the surface layer, that the temperature difference of 20° C., and that a cooling rate of 2 W mˆ{−2} will give a one degree equilibrium cooling of the surface, 100 MW of installed systems 300 will be able to cool a region of about 11,000 square kilometers. Suitable distribution sites would include any tropical ocean areas. Further illustrated is a control system 500 that communicates, preferably wirelessly, with of the distribution systems 300, and allows a master station 510 (located in Florida in this example) to control and monitor, through a local control system 520 at each of the distributions systems 300, the operation of each, in particular the amount and area of discharge of the cool sea water that is discharged to the surface. Examples of such control are turning on all systems 300 that are in the predicted path of a cyclone, or turning on all systems 300, for example.

The control system 500 can thus be used to control regional surface water temperatures throughout the year and thus decrease the surface water temperatures further by increasing cold water flow to the surface of the ocean from specific or all systems 300 in the advent of storm formation to provide additional protection.

FIG. 6 illustrates a geographical area that surrounds two adjacent distribution systems 300, and illustrates coverage areas 600-1 and 600-2, with an overlap area 620. If properly scaled, each distribution system 300 is capable of operating upon 356 kiloliters of sea water per second, and can distribute cool sea water to a 11,000 square km area, and reduce the temperature of the sea surface water in that area, typically from up to 30.5° C. to 26.7° c. Smaller distribution systems 300, which can thereby influence a different range of surface areas, from 1000-11,000 square km areas, can also be used, and an appropriate match between the number of units used and the surface area that is being protected then made.

To limit impact on the surrounding environment, the mixing area 12 of FIG. 2 or similar structure is used to mix cold water from deep below the surface of the sea with the warm surface water to produce a less drastic temperature change. Salinity and temperature differences can cause difficulties in large scale introduction without proper mixing and would not have the desired distribution along current flows.

The discharged cold water from a distribution system 300 according to the present invention is discharged completely on the surface, or some on the surface and other at another depth. For instance, some but not all of the discharged water can be returned to a very deep depth in order to maintain the surface sea water at a desired temperature of no more than 26° C. to provide a variable ratio depending on surface conditions necessary to maintain a desired SST. For example, when storm formation is imminent, ratios can be adjusted to further cool the surface waters, providing an additional buffer against storm formation and growth while providing only little stress to the environment—minimal compared to the ravages of a hurricane passing the area.

Accordingly the method of cooling sea surface temperatures described herein will reduce the intensity of tropical cyclones and prevent the formation of tropical cyclones. It can also be used to return the aquatic environment to more suitable temperatures reducing occurrences of red tide and coral bleaching. Increased algae growth from the mineral rich pumping device discharge will absorb carbon from the atmosphere at an increased rate and provide a basis for higher life forms on the food chain. The absorption of carbon and other green house gases will reduce the effects of global warming. The lowering of sea surface temperatures will also have the effect of increasing the strength of the ThermoHaline Currents that transport heat around the Earth. Lowering of the sea surface temperatures allows the waters to hold a larger volume of dissolved gases decreasing hypoxic or dead zones that contain little or no oxygen.

While the description contains much specificity, these should not be construed as limitations on the scope of the invention, but as exemplifications of the presently preferred embodiments thereof. Many other ramifications and variations are possible within the teachings of the invention. For example, the pumping device could form the core for a habitable artificial island for research, recreational and residential purposes providing a unique lifestyle having many of the benefits of living on land, and many benefits of living at sea.

Thus the scope of the invention should be determined by the appended claims and their legal equivalents, and not by the examples given.

What is claimed:

1. A method of lowering sea surface temperatures to reduce tropical cyclone intensity using a plurality of pumping distribution devices that pump cold sea water from a sea depth to a sea surface comprising the steps of:
positioning a plurality of the pumping distribution devices along sea currents;
pumping the cold sea water from the sea depth to the sea surface with each of the plurality of pumping distribution devices;
obtaining discharge water having a lower temperature than the surface sea water, wherein water derived from the cold sea water is used to obtain the discharge water; and
returning the discharge water to a predetermined area of the sea surface in a quantity sufficient to obtain cooled surface water and affect a cooling of at least a 1000 square km area of the surface water, thereby limiting tropical cyclone intensity of any tropical storm over the at least 1000 square km area.

2. The method according to claim 1 further including the step of using the discharge water to reduce coral bleaching and red tide occurrences.

3. The method according to claim 1 further including the step of using the discharge water to create algae blooms that absorb carbon and other green house gases from the water and atmosphere and provide food for higher aquatic life forms.

4. The method according to claim 1 where the discharge water increases gas storage capability as compared to the sea surface water, decreasing hypoxic or dead zones in oceans.

5. The method according to claim 1 wherein the cooled surface water strengthens deep ocean conveyor currents.

6. The method according to claim 1 further including the step of producing energy using at least some of the pumped sea water and at least some of the surface sea water using an ocean thermal energy conversion device, wherein the step of producing energy results in used water, and wherein the water derived from the cold sea water used in the step of obtaining is the used water from the step of producing.

7. The method according to claim 6 wherein the water derived from the cold sea water used in the step of obtaining is a mixture of the used water and other cold sea water.

8. The method according to claim 6 wherein electrical energy is generated during the step of producing.

9. The method according to claim 8 further including the step of centrally controlling at least some controls from each of the plurality of pumping distribution devices using a master controller.

10. The method according to claim 9 wherein the step of centrally controlling controls an output amount of the discharge water at some of the plurality of pumping distribution devices so that the predetermined areas associated with adjacent ones of the some of the plurality of pumping distribution devices overlap.

11. The method according to claim 9 wherein the step of centrally controlling controls an output amount of the discharge water at some of the plurality of pumping distribution devices based upon a predicted path of the tropical cyclone.

12. The method according to claim 9 wherein the step of centrally controlling controls an amount of the electrical energy produced by some of the plurality of pumping distribution devices.

13. The method according to claim 1 further including the step of centrally controlling at least some controls from each of the plurality of pumping distribution devices using a master controller.

14. The method according to claim 13 wherein the step of centrally controlling controls an output amount of the discharge water at some of the plurality of pumping distribution devices so that the predetermined areas associated with adjacent ones of the some of the plurality of pumping distribution devices overlap.

15. The method according to claim 13 wherein the step of centrally controlling controls an output amount of the discharge water at some of the plurality of pumping distribution devices based upon a predicted path of the tropical cyclone.

16. The method according to claim 15 wherein the output amount at each of the some plurality of pumping distribution devices that are within the predicted path of the tropical cyclone is optimized to maximize the reduction in intensity of the tropical cyclone.

17. The method according to claim 1 wherein the step of obtaining provides the discharge water at a temperature that is within a range of 2-18° C. of sea surface water temperature.

18. The method according to claim 1 wherein the step of returning is assisted by the discharge water being at least partially distributed by the sea currents.

19. A distribution system that generates electricity and reduces surface temperature of surface sea water using deep sea water comprising:
a thermal energy conversion device that uses the deep sea water and the surface sea water to produce electricity and that provides used water that has a temperature that is cooler than the surface sea water at the sea surface; and
a water distribution system for continuously distributing over a period of time the discharge water over the sea surface to reduce the surface temperature of the surface sea water, the water distribution system including a mixing tank that produces discharge water that has a temperature within a range of 2-18° C. of sea surface water temperature using at least the used water.

20. The system according to claim 19 wherein the mixing tank further includes an inlet for surface sea water and mixes surface sea water with the used water to produce the discharge water.

21. The system according to claim 19 wherein the water distribution system further includes an array of distribution outlets that distribute the discharge water to a plurality of locations around the water distribution system.

22. The system according to claim 21 wherein the thermal energy conversion device further includes a distilled water distribution system.

23. The system according to claim 22 further including a plurality of platforms that each support commercial sea farming.

24. The system according to claim 15 further including a local communications control system, the local communications control system receiving signals that control an amount of discharge water that is produced.

25. The system according to claim 20 wherein the receiving signals include a signal that specifies production of a maximum amount of discharge water.

26. The system according to claim 20 wherein the water distribution system has a capacity that allows for continuous distribution of the discharge water to cover an area of at least 1000 square km.
